(19) United States
(12) Patent Application Publication
(10) Pub. No.: US 2025/0180714 A1
(43) Pub. Date: Jun. 5, 2025

(54) COMPUTER SYSTEM, METHOD, AND PROGRAM

(71) Applicant: Sony Interactive Entertainment Inc., Tokyo (JP)

(72) Inventor: Makoto KOIZUMI, Tokyo (JP)

(73) Assignee: Sony Interactive Entertainment Inc., Tokyo (JP)

(21) Appl. No.: 18/845,001

(22) PCT Filed: Mar. 24, 2022
(86) PCT No.: PCT/JP2022/014177

§ 371 Date: Sep. 9, 2024

(51) Int. Cl. G01S 7/4865; G01S 17/08

(52) U.S. Cl. CPC G01S 7/4865; G01S 17/08

(57) ABSTRACT

A computer system for calculating a distance to an object is provided. The computer system includes a memory for storing a program code and a processor for executing operation in accordance with the program code. The operation includes emitting irradiation light to a dToF sensor in accordance with a predetermined spatial pattern, acquiring a first distance calculated in reference to a time difference between emission of irradiation light and reception of reflected light from the irradiation light reflected by the object by the dToF sensor, and calculating a second distance by comparing a shape of a reflection image formed from the reflected light captured by a vision sensor with the predetermined spatial pattern.

### TECHNICAL FIELD

The present invention relates to a computer system, a method, and a program.

### BACKGROUND ART

ToF (Time of Flight) sensors that measure the distance to an object on the basis of time of flight of light are used, for example, to acquire three-dimensional information of a subject and are roughly classified into a dToF (direct ToF) type that measures the time difference between emission of irradiation light and reception of reflected light and an iToF (indirect ToF) type that accumulates reflected light to detect a phase difference between the reflected light and the emitted light and measure the distance. A technology relating to a ToF sensor is disclosed, for example, in PTL 1.

### CITATION LIST

### Patent Literature

### PTL 1

Japanese Patent Laid-open No. 2019-078748

### SUMMARY

### Technical Problem

In a case where measurement in a long range is to be carried out by such a ToF sensor as described above, the power of irradiation light is set high taking attenuation of light used for the irradiation into consideration. However, in this case, if a measurement target having high reflectance is present in a short range, then the amount of reflected light becomes excessively great, and this sometimes causes distortion in the histogram shape of reflected light detected during measurement time, resulting in calculation of a distance shorter than the actual distance.

Therefore, it is an object of the present invention to provide a computer system, a method, and a program that can utilize a ToF sensor to measure the distance to an object with high accuracy in a wide range from a long distance to a short distance.

### Solution to Problem

According to a certain aspect of the present invention, there is provided a computer system for calculating a distance to an object, including a memory for storing a program code and a processor for executing operation in accordance with the program code, in which the operation includes emitting irradiation light to a dToF sensor in accordance with a predetermined spatial pattern, acquiring a first distance calculated in reference to a time difference between emission of the irradiation light and reception, by the dToF sensor, of reflected light from the irradiation light reflected by the object, and calculating a second distance by comparing a shape of a reflection image formed from the reflected light captured by a vision sensor with the predetermined spatial pattern.

According to another aspect of the present invention, there is provided a method for calculating a distance to an object, the method including, by an operation executed by a processor in accordance with a program code stored in a memory, emitting irradiation light to a dToF sensor in accordance with a predetermined spatial pattern, acquiring a first distance calculated in reference to a time difference between emission of the irradiation light and reception, by the dToF sensor, of reflected light from the irradiation light reflected by the object, and calculating a second distance by comparing a shape of a reflection image formed from the reflected light captured by a vision sensor with the predetermined spatial pattern.

According to a further aspect of the present invention, there is provided a program for calculating a distance to an object, in which an operation executed by a processor in accordance with the program includes emitting irradiation light to a dToF sensor in accordance with a predetermined spatial pattern, acquiring a first distance calculated in reference to a time difference between emission of the irradiation light and reception, by the dToF sensor, of reflected light from the irradiation light reflected by the object, and calculating a second distance by comparing a shape of a reflection image formed from the reflected light captured by a vision sensor with the predetermined spatial pattern.

### BRIEF DESCRIPTION OF DRAWINGS

FIG. 1 is a diagram depicting an example of a system according to an embodiment of the present invention.

FIG. 2 is a diagram conceptively depicting functions incorporated in the system depicted in FIG. 1.

FIG. 3 is a view schematically illustrating a principle of calculation of a distance from an output of an EVS (Event-based Vision Sensor).

FIG. 4 is a diagram schematically illustrating an example in which the inside of an angle of view is scanned with a pattern of irradiation light.

FIG. 5 is a flow chart depicting an example of an integration process of distances in the system depicted in FIG. 1.

### DESCRIPTION OF EMBODIMENT

In the following, several embodiments of the present invention are described in detail with reference to the accompanying drawings. It is to be noted that, in the present specification and the drawings, components having substantially the same functional configurations are denoted by identical reference signs and overlapping description of them is omitted.

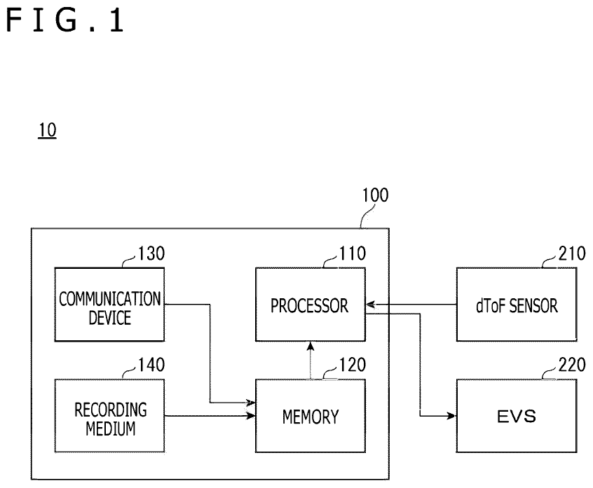

FIG. 1 is a diagram depicting an example of a system according to an embodiment of the present invention. In the example depicted, a system 10 includes a computer 100, a dToF sensor 210, and an EVS 220. The computer 100 is, for example, a game machine, a personal computer (PC), or a network-connected server apparatus. The dToF sensor 210 includes a light source of irradiation light and a light receiving element, and measures the time difference between emission of irradiation light and reception of reflected light of irradiation light reflected by an object. More particularly, the irradiation light is a laser light pulse. The EVS 220 is also called an EDS (Event Driven Sensor), an event camera, or a DVS (Dynamic Vision Sensor), and is a vision sensor that includes a sensor array including sensors each including a light receiving element. When the sensor detects an intensity change of incident light, more particularly, a luminance change on a surface of an object, the EVS 220 generates an event signal that includes identification information of the sensor and information concerning the polarity of the luminance change.

Further, as depicted in FIG. 1, the computer 100 includes a processor 110 and a memory 120. The processor 110 includes a processing circuit such as a CPU (Central Processing Unit), a DSP (Digital Signal Processor), an ASIC (Application Specific Integrated Circuit), and/or an FPGA (Field-Programmable Gate Array), for example. Meanwhile, the memory 120 includes various storage devices such as a ROM (Read Only Memory), a RAM (Random Access Memory), and/or an HDD (Hard Disk Drive), for example. The processor 110 executes such operation as described below in accordance with program codes stored in the memory 120.

The computer 100 further includes a communication device 130 and a recording medium 140. For example, program codes for causing the processor 110 to operate in such a manner as hereinafter described may be received from an external apparatus through the communication device 130 and stored into the memory 120. Alternatively, the program codes may be read from the recording medium 140 into the memory 120. The recording medium 140 includes a removable recording medium such as a semiconductor memory, a magnetic disk, an optical disk, or a magnetooptical disk, for example, and a driver for the removable recording medium.

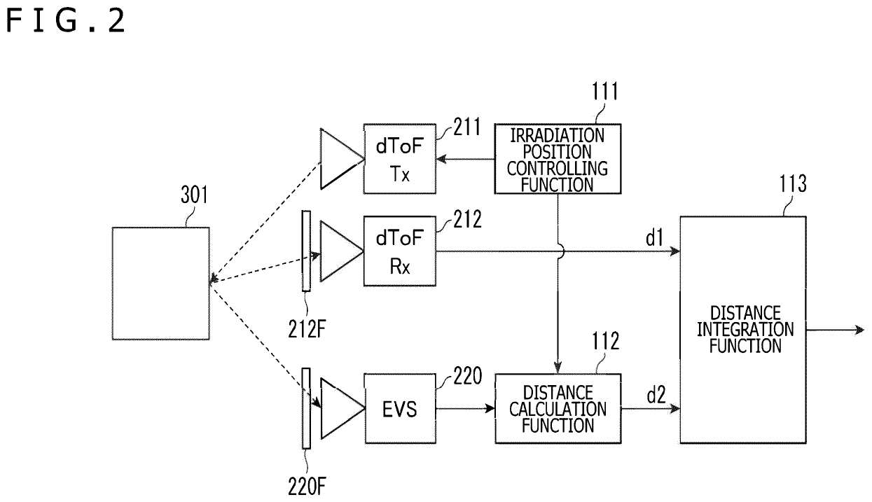

FIG. 2 is a diagram conceptually depicting functions incorporated in the system depicted in FIG. 1. As described hereinabove, the dToF sensor 210 includes an irradiation function 211 that emits a laser light pulse and a light receiving function 212 that receives reflected light. Here, the irradiation function 211 is controlled by the processor 110 of the computer 100 in such a manner as to emit a laser light pulse in accordance with a predetermined spatial pattern, particularly, a linear or dotted-line pattern. In FIG. 2, this function is indicated as an irradiation position controlling function 111. Since the dToF sensor 210 is often configured in such a manner that the emission timing of a laser light pulse is originally displaced for each irradiation position for the sake of eye safety, the function of the irradiation position controlling function 111 for controlling the dToF sensor 210 such that the laser light pulse is emitted in accordance with a predetermined spatial pattern can be incorporated relatively easily. It is to be noted that, in the present embodiment, the laser light pulse is light in an infrared (IR) wavelength, and the light receiving function 212 receives the reflected light through an IR transmission filter 212F. Also the EVS 220 generates an event signal with light received through an IR transmission filter 220F.

Here, although the dToF sensor 210 can measure, if the emission timing of irradiation light for each pixel is specified, the time difference between emission of irradiation light and reception of reflected light and calculate the distance to an object 301 in reference to the time difference, in the present embodiment, the irradiation light that is emitted for each pixel is controlled in such a manner as to form a predetermined spatial pattern, thereby allowing the distance to the object 301 to be calculated not only from an output of the dToF sensor 210 but also from an output of the EVS 220. In FIG. 2, this function is indicated as a distance calculation function 112.

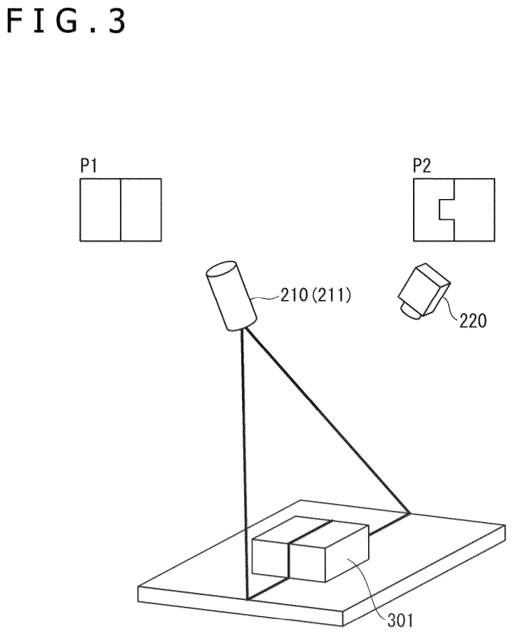

FIG. 3 is a view schematically illustrating a principle of calculation of a distance from an output of the EVS. In the present embodiment, a method called light section method is used to calculate the distance to the object 301 also from an output of the EVS 220 in addition to an output of the dToF sensor 210. In the example depicted in FIG. 3, a laser light pulse is emitted in accordance with a linear pattern (denoted as P1) by the irradiation function 211 of the dToF sensor 210. While, when a laser light pulse is reflected by the object 301, a reflection image is formed from the reflected light, at a portion of the reflection image where the object 301 exists, the shape of the reflection image (denoted as P2) changes in comparison with that of the original pattern due to a difference in distance to the background. The reflection image can be captured as a luminance change on the surface of the object 301 from an event signal generated by the EVS 220. If the positional relation between the dToF sensor 210 and the EVS 220 is known, then it is possible to reversely calculate the distance to the object 301 by comparing the shape of the captured reflection image with that of the pattern of the irradiation light.

Such calculation of the distance that uses the shape of the reflection image of the laser light pulse as described above is high in accuracy in the short distance range in comparison with that of the dToF sensor 210. On the other hand, in the long distance range, the accuracy of the dToF sensor 210 is higher. Accordingly, by increasing the power of the irradiation light with the dToF sensor 210 to carry out measurement of high accuracy in the long distance range and calculating, in the short distance range in which there is a possibility of a decrease in accuracy as a result of an increase in the power of the irradiation light of the dToF sensor 210, the distance with use of the shape of the reflection image by the EVS 220, the distance to the object can be measured with high accuracy in a wide range from the long distance to the short distance. It is to be noted that the spatial pattern of the irradiation light is not limited to a continuous linear pattern and may be a dotted-line pattern formed from discrete dots. Further, since it is sufficient if such a comparison in shape as described above can be performed, the pattern is not limited to a linear pattern and may be a curved pattern.

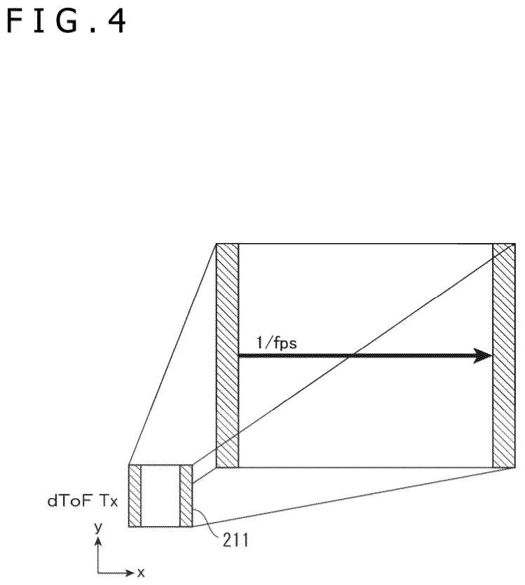

FIG. 4 is a view schematically illustrating an example in which the inside of an angle of view is scanned with a pattern of irradiation light. For example, in a case where the irradiation function 211 of the dToF sensor 210 emits a laser light pulse in accordance with a linear pattern as in the example described above, the inside of the angle of view can be scanned by parallel movement of the pattern. In particular, for example, in a case where pixels of the dToF sensor 210 are arrayed in an x direction and a y direction in FIG. 4, the inside of the angle of view is scanned by emission of a laser light pulse to the pixels arranged in a linear region extending in the y direction, to carry out measurement, and sequential movement of the measurement region in the x direction perpendicular to the y direction. The speed of the movement in this case is equal to a length obtained by dividing the width of the angle of view by an fps (frame per second) of the dToF sensor 210. Since the measurement for each pixel of the dToF sensor 210 is carried out independently, a laser pulse may be emitted to the next region before reception of reflection light in a certain region ends.

Described with reference to FIG. 2 again, a first distance d1 calculated in reference to the time difference between emission of irradiation light and reception of reflected light by the light receiving function 212 of the dToF sensor 210 and a second distance d2 calculated by the distance calculation function 112 from an event signal generated by the EVS 220 are integrated by a distance integration function 113. In particular, the distance integration function 113 integrates the first distance d1 calculated by the dToF sensor 210 and the second distance d2 calculated by the distance calculation function 112 such that the first distance d1 is outputted in the long distance range and the second distance d2 is outputted in the short distance range.

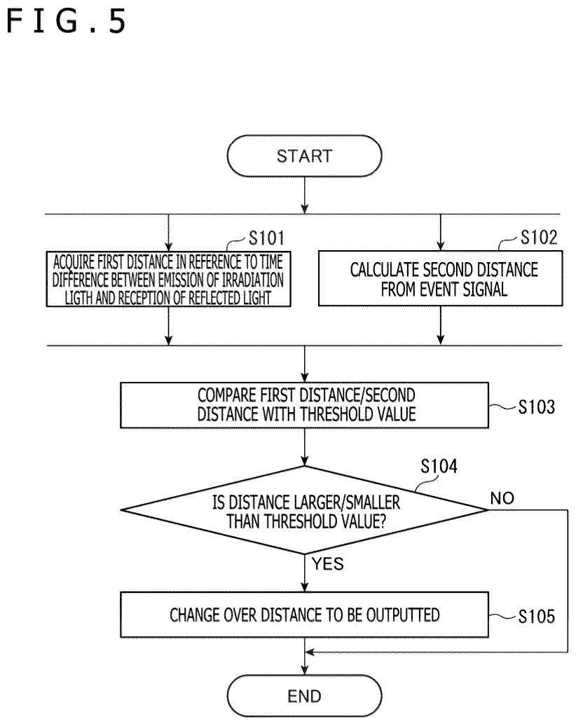

FIG. 5 is a flow chart depicting an example of a distance integration process in the system depicted in FIG. 1. The processor 110 of the computer 100 acquires the first distance d1 calculated in reference to the time difference between emission of irradiation light and reception of reflected light measured by the dToF sensor 210 (step S101) and calculates the second distance d2 from the event signal generated by the EVS 220 (step S102). It is to be noted that, if the distances from the dToF sensor 210 and the EVS 220 to the object are equal to each other, the timing at which reflected light is received by the dToF sensor 210 and the timing at which the event signal indicative of a reflection image is generated by the EVS 220 are the same as each other, so that it is relatively easy to associate the acquired first distance d1 with the calculated second distance d2. The processor 110 may associate the first distance d1 with the second distance d2 calculated at each point of time by taking an internal delay in the dToF sensor 210 and signal generation in the EVS 220, a process delay in the distance calculation function 112, and so forth into consideration.

The processor 110 executes, by the function of the distance integration function 113 thereof, a comparison of one of the first distance d1 and the second distance d2 associated with each other with a predetermined threshold value (step S103), and changes over the distance to be outputted according to a result of the comparison (steps S104 and S105). Since the distance integration function 113 integrates the distances such that the first distance d1 is outputted in the long distance range and the second distance d2 is outputted in the short distance range, in steps S103 to S105 described above, the processes are executed, for example, in the following manner. First, in a case where the first distance d1 is outputted at the point of time, the distance integration function 113 compares the first distance d1 with the threshold value, and outputs, in a case where the first distance d1 is smaller than the threshold value, the second distance d2 in place of the first distance d1. On the other hand, in a case where the second distance d2 is outputted at the point of time, the distance integration function 113 compares the second distance d2 with the threshold value and outputs, in a case where the second distance d2 is larger than the threshold value, the first distance d1 in place of the second distance d2. Such processes as described above make it possible to use an appropriate measurement method according to the distance to be measured, in other words, to selectively use measurement that depends on the dToF sensor 210 in the long distance range and measurement that depends on the EVS 220 and the distance calculation function 112 in the short distance range.

According to such an embodiment of the present invention as described above, by selectively using an appropriate measurement method according to the distance to be measured, that is, measurement depending on the dToF sensor 210 in the long distance range and measurement depending on the EVS 220 and the distance calculation function 112 in the short distance range, the distance to an object can be measured with high accuracy in a wide range from the long distance to the short distance.

Such a configuration as described above can be effective for a sensor that is incorporated in a robot of the autonomous type that can be self-propelled avoiding an obstacle and can grasp an object at hand. In this case, for example, when the robot is self-propelled, the distance in the long distance range is calculated accurately with use of the dToF sensor 210, while in a case where the robot grasps an object at hand, the distance in the short distance range is calculated accurately with use of the EVS 220, and by this, operation of the robot can be executed appropriately in both cases. Further, such a configuration as described above can be effective also in a case where augmented reality (AR) is experienced with use of a head-mounted display (HMD) or the like. In this case, although it is necessary to accurately recognize the distance to an object in a range from the long distance range to the short distance range in order to perform determination of occlusion, the configuration described above makes it possible to accurately measure the distance in the individual ranges.

It is to be noted that, although the vision sensor used for calculation of the distance that uses the shape of a reflection image of a laser light pulse is, in the embodiment described above, the EVS 220, in a different embodiment, a frame-based vision sensor as exemplified by a monochromatic high-speed camera may be used. Since the EVS allows reading out therefrom at a high speed and can be made high in both the temporal resolution and the spatial resolution, it is ready even if the irradiation position of the laser light pulse changes at a high speed. Further, since the EVS has a wide dynamic range, it can be ready also for a luminance change on the surface of an object with bright reflected light at the short distance. From the points described, the EVS is advantageous for use for calculation of the distance in which the shape of the reflection image is used as in the embodiment described above. However, since the advantages are not necessarily achieved only by the EVS, it is also possible to use a vision sensor of a different type as in the foregoing description.

Further, while, in the embodiment described above, the distance integration function 113 is incorporated in the processor 110 of the computer 100 in addition to the irradiation position controlling function 111 and the distance calculation function 112, the distance integration function 113 may not necessarily be incorporated. For example, the first distance d1 measured by the dToF sensor 210 and the second distance d2 measured by the EVS 220 and the distance calculation function 112 may be outputted as they are as two distances, and, for example, application software that uses distance information may determine which one of the distances is to be outputted.

Although the embodiment of the present invention has been described in detail with reference to the accompanying drawings, the present invention is not restricted to such an embodiment. It is apparent that persons who have common knowledge in the technical field to which the present invention pertains could arrive at various alterations or modifications without departing from the category of the technical ideals described in the claims, and it is construed that they also naturally fall within the scope of the technology of the present invention.

### REFERENCE SIGNS LIST

10: System
100: Computer
110: Processor
111: Irradiation position controlling function
112: Distance calculation function
113: Distance integration function
120: Memory
130: Communication device
140: Recording medium
210: dToF sensor
211: Irradiation function
212: Light receiving function
212F: IR transmission filter
220: EVS
220F: IR transmission filter
301: Object

1. A computer system for calculating a distance to an object, comprising:
a memory for storing a program code; and
a processor for executing operation in accordance with the program code, wherein
the operation includes
emitting irradiation light to a direct time-of-flight sensor in accordance with a predetermined spatial pattern,
acquiring a first distance calculated in reference to a time difference between emission of irradiation light and reception, by the direct time-of-flight sensor, of reflected light from the irradiation light reflected by the object, and
calculating a second distance by comparing a shape of a reflection image formed from the reflected light captured by a vision sensor with the predetermined spatial pattern.

2. The computer system according to claim 1, wherein the vision sensor is an event-based vision sensor.

3. The computer system according to claim 1, wherein the predetermined spatial pattern is a linear pattern or a dotted-line pattern.

4. The computer system according to claim 3, wherein the emitting the irradiation light includes scanning inside of an angle of view by parallelly moving the predetermined spatial pattern.

5. The computer system according to claim 1, wherein the operation further includes integrating the first distance and the second distance, and
the integrating the first distance and the second distance includes outputting, in a case where the first distance is smaller than a first threshold value, the second distance in place of the first distance or outputting, in a case where the second distance is larger than a second threshold value, the first distance in place of the second distance.

6. A method for calculating a distance to an object, the method comprising:
by operation executed by a processor in accordance with a program code stored in a memory, emitting irradiation light to a direct time-of-flight sensor in accordance with a predetermined spatial pattern;
acquiring a first distance calculated in reference to a time difference between emission of irradiation light and reception, by the direct time-of-flight sensor, of reflected light from the irradiation light reflected by the object; and
calculating a second distance by comparing a shape of a reflection image formed from the reflected light captured by a vision sensor with the predetermined spatial pattern.

7. A program for calculating a distance to an object, comprising:
by operation executed by a processor in accordance with the program,
emitting irradiation light to a direct time-of-flight sensor in accordance with a predetermined spatial pattern;
acquiring a first distance calculated in reference to a time difference between emission of irradiation light and reception, by the direct time-of-flight sensor, of reflected light from the irradiation light reflected by the object; and
calculating a second distance by comparing a shape of a reflection image formed from the reflected light captured by a vision sensor with the predetermined spatial pattern.
